(19) United States
(12) Patent Application Publication
(10) Pub. No.: US 2002/0049790 A1
(43) Pub. Date: Apr. 25, 2002

(54) Data interchange format transformation method and data dictionary used therefor

(76) Inventors: Jeffrey M Ricker, Putnam Valley, NY (US); David W. Hurst, Chicago, IL (US); David E. Jakopac, Elk Grove Village, IL (US); Yerasi Chandrasekhara Reddy, Lombard, IL (US); Kevin Kail, Great Falls, VA (US)

Correspondence Address: NIXON PEABODY, LLP, 8180 GREENSBORO DRIVE, SUITE 800, MCLEAN, VA, 22102, US

(21) Appl. No.: 09/896,125

(22) Filed: Jul. 2, 2001

Related U.S. Application Data
(60) Provisional application No. 60/223,859, filed on Aug. 8, 2000.

(51) Int. Cl. G06F 17/21

(52) U.S. Cl. 707/513

(57) ABSTRACT

A method for expressing the content of data interchange format messages, such as Electronic Data Interchange (EDI) documents, in a markup language, such as Extensible Markup Language (XML). One or more XML documents are created which define an XML data dictionary expressing the EDI semantics for transaction sets, segments and elements. The data dictionary can be generated as plural files each representing a piece of the EDI semantics. Pieces of the EDI document are read and used to generate XML tags to define elements of the XML document. Attributes and values of the XML elements are set based on the data dictionary and established rules. The use of the data dictionaries permits the human readable metadata of EDI to be incorporated into an XML document expressing the underlying data of an EDI document.

### RELATED APPLICATION DATA

This application claims benefit from provisional application Ser. Nos. 60/223,859 filed on Aug. 8, 2000 and Ser. No. 60/215,873 filed on Jun. 30, 2000, the disclosures of which are incorporated herein by reference.

### COPYRIGHT NOTICE

This application contains material that is subject to copyright protection. The copyright owner has no objection to the facsimile reproduction by anyone of the document or disclosure, as it appears in the Patent and Trademark Office Records, but otherwise reserves all copyrights whatsoever.

### BACKGROUND

The invention relates generally to data transformation and more specifically to a method for transforming data from one data interchange format, such as Electronic Data Interchange Format, to another data interchange format.

Electronic commerce, sometimes known as “e-commerce” is well known generally. The objective of e-commerce is to eliminate manual trading processes by allowing internal applications of different entities, known as “trading partners,” to directly exchange information. In traditional commerce, both customers and vendors, as trading partners, may be automated internally, but their systems are usually isolated from each other. Therefore, trading partners must often use manual processes such as mail, e-mail, facsimile, meetings and phone calls to exchange information relating to transactions. The objective of e-commerce is to minimize the need for manual information exchange in traditional commerce. Many large companies have effected electronic commerce using a data interchange format known as “Electronic Data Interchange” (EDI). EDI has proven itself to be very effective.

However, EDI is too complicated and expensive for many small and many midsize companies. Specifically, when EDI was created, the size of messages, i.e. documents, was a primary concern because the technology only permitted very low data transfer rates. Accordingly, EDI messages are very compressed and use codes to represent complex values. Metadata, i.e. data describing data, is stripped from an EDI message to minimize the message size. The metadata is correlated to the codes in separate documents known as an EDI data dictionary. However, this makes the message difficult for humans to read and debug. The complexity of EDI requires that programmers have a great deal of training, which in turn makes EDI applications expensive to buy and maintain. As a result, EDI has not been universally adopted and has not fundamentally changed the way business is conducted. However, where implemented, EDI eliminates manual processes by allowing the internal applications of different companies to exchange information directly.

The Internet and extensible markup language (XML) have created forms of data interchange that are less expensive and thus have lowered the barriers to entry for accomplishing data interchange generally and e-commerce in particular. Many newer e-commerce systems currently are based on XML. Similar to EDI systems, these newer systems allow the internal applications of different companies to share information directly and thus eliminate the need for manual communication relating to transactions. Data is placed between descriptive XML tags as metadata. XML messages are thus rich in metadata making them easy to read and debug. Further, the simplicity of XML permits persons with limited training to develop and maintain XML-based applications, in turn making XML applications less expensive to implement.

Notwithstanding the characterization of EDI as a “standard,” there are may approaches to EDI. First, EDI is defined by two distinct standards, ASC X12 and EDIFACT, both of which are hereby incorporated herein by reference. ASC X12 is the standard for EDI in the United States and has evolved over the years. EDIFACT is the international standard, endorsed by the United Nations and designed from the ground up beginning in 1985. Further, X12 and EDIFACT each have several version releases of their message formats. Compatibility between versions is not always straightforward. In addition, there are other groups such as the Open Buying Initiative (OBI) proposing standards for implementing EDI messages over hypertext transfer protocol (HTTP).

XML-based e-commerce is even more diversified. As of August 2000, nearly one hundred XML-only standards were under development. Microsoft™, Ariba™, IBM™ and almost 30 other technology companies have combined to create UDDI (Universal Description Discovery and Integration), which will allows companies to publish information about the Web services they offer in a Universal Business Registry that will be accessible by anyone. RosettaNet™ is developing XML standards for product catalogs. Commerce One™ has created the common business library (CBL). Ariba™ has developed commerce XML (cXML), a proposed standard for catalogs and purchase orders.

EDI works well and has been accepted by many large corporations. Further, these corporations have a large investment in EDI and thus cannot easily abandon it. The expense of EDI is rooted in its complexity and its complexity is based in its compressed, cryptic message formats without metadata. XML overcomes this complex syntax by preserving the metadata within the message.

It is known to interface XML and EDI based systems. For example, the XML-EDI Group, ANSI, Ariba™, CommerceOne™ and Edifecs Commerce™ have proposed various approaches for encoding EDI messages in XML. Essentially, each of these approaches includes human-readable metadata representing portions of the EDI standards in the form of XML attributes and tags. In other words, specific sections of a limited set of EDI messages (e.g. Shipping Address for a Purchase Order) have been hard-coded into the XML information models (represented by either DTDs or Schemas). This approach requires a very large number of XML tags and attributes having various names that can be expressed in various ways. For example, the metadata “purchase order number” from the X12 data dictionary can be expressed as “Purchase Order No”, “Purchase_Order_Number”, or the like. Any change to a document requires rewriting of the DTD. Each transaction set has a unique corresponding DTD, and each DTD may include hundreds of individual element definitions. Therefore, each document has to be unique and may be incompatible with other documents. Edifecs has develop Guideline XML (gXML) to facilitate the exchange of EDI implementation guidelines using XML. While some of these provide support for certain EDI transactions, known XML-based projects do not retain the semantics of EDI and thus do not provide the flexibility necessary to support a variety of EDI transactions.

For these reasons, many small to medium size enterprise (SME) buyers currently communicate with large EDI-enabled corporations via phone, facsimile and email since EDI is not a viable option for such buyers. It would be beneficial to leverage the semantics of EDI in a flexible manner to interface EDI and XML systems

### SUMMARY OF THE INVENTION

A first aspect of the invention is a method for expressing the data of an EDI document as an XML document. The method comprises reading a piece of the EDI document, designating an XML element with an XML tag, setting the EDI code corresponding to the piece as an attribute of the XML element, designating a child element of the XML element with a child tag, and generating a human readable description of the EDI code as the contents of the child element. If the piece has a corresponding value, a grandchild element of the XML element is generated and the value is set as the contents of the grandchild element. These steps are repeated for each desired piece of the EDI document.

A second aspect of the invention is also a method for expressing the data of an EDI document as an XML document. The method comprises reading a piece of the EDI document, selecting a tag structure to designate an XML element corresponding to the piece, incorporating the EDI code of the piece into the tag structure to create an XML tag designating an XML element, and setting a human readable description corresponding to the EDI code as a value of the XML attribute of the XML element. If the piece has a corresponding value, the value of the piece is set as the contents of the XML element. These steps are repeated for each desired piece of the EDI document.

A third aspect of the invention is an XML document expressing the semantics of an EDI data dictionary. The XML document comprises an XML element including pair of corresponding tags, and an attribute that is equivalent to an EDI code in the EDI data dictionary, and a child element including a pair of corresponding tags and a value that is equivalent to the metadata associated with the EDI code in the EDI data dictionary.

A fourth aspect of the invention is an XML document having a plurality of elements designated by tags and expressing the underlying data and semantics of an EDI document. At least some of said elements of the XML document comprise the unique EDI code representing the type of information in the element and human readable metadata corresponding to the type of information in the element.

### BRIEF DESCRIPTION OF THE DRAWING

The invention will be described through a preferred embodiment and the attached drawing in which:

FIG. 1 is a block diagram of a data interchange transformation system of the preferred embodiment;

FIG. 2 is a flowchart of the first example of a transformation process of the preferred embodiment;

FIG. 3 is a flowchart of the second example of a transformation process of the preferred embodiment.

The following description utilizes many terms of art, the definitions of which are provided below.

### GLOSSARY

Attribute—a characteristic of a specific element. In XML, attributes are placed inside the tags of an element but are distinct from the element value.

Composite Element—An element in the data dictionary that contains references to other elements.

Data Dictionary—A document(s) that expresses the basic organization of other documents. For example, an EDI data dictionary correlates EDI codes to human readable metadata.

Data Interchange Format—A data format, structure, or protocol that facilitates the transfer of data between computing devices running various applications, without the need for manual intervention.

Document Type Definition—The description of the information model of an XML document using an SGML syntax.

EDI—A data interchange format that enables the machine-to-machine exchange of business data in standard formats. In EDI, information is organized according to a specified format set by trading partners. Traditional applications of EDI are purchase orders, invoices, shipping orders and payments. There are two commonly accepted EDI standards available: X12 (utilized primarily in the United States) and EDIFACT (utilized by most other countries).

EDI Transaction Set—a collection of segments that form an EDI business document.

Element—A piece of a specific type of data, and any associated markup tags or metadata. In XML, an element is defined by a pair of corresponding tags that may host zero or more attributes and may contain additional tags or data values. In EDI, an element is the most granular level of data available (similar to a field within a record). Typical EDI elements include Unit Price, Quantity and Date.

Information Model—A document that defines and describes the tags (sometimes referred to as elements), attributes, data structures and values that can appear within a valid instance of the XML document. An information model is optional—XML documents need not be validated or have information models associated with them.

Loop—A potentially repeating data structure within EDI (made up of one or more segments, each of which may contain one or more elements. An example includes Product Line Item Descriptions within a Purchase Order.

Markup Language—A computer readable language including syntactically delimited characters that an be associated with data to represent the description of the data, the structure of the data, display characteristics of the data, processing instructions to be applied to the data, or other characteristics of the data.

Metadata—A definition or description of data—data that describes other data. In XML, metadata is represented by the tags, attributes and data structures used in a particular document.

Meta Model—The structural relationship between elements in a document.

Schema—The structural definition, i.e. description of the information model, of an XML document in an XML syntax, including support for data types.

Segment—A group of elements within an EDI business transaction. Typical segments include Transaction Set Headers (which include routing information), Ship To Address, and Pricing Information.

Semantics—The relationship between elements of a document and their real world significance or meaning.

Standard Exchange Format (SEF)—A open EDI standard for defining data segments, data elements and composite data elements that make up EDI transaction sets. SEF files provide EDI implementation guidelines in machine readable format so that translators can directly import the file and use the implementation guidelines to translate or map EDI files.

Trading Partner—A distinct entity participating in e-commerce.

Transaction Set—The highest level element within a given EDI business transaction. Typical transaction sets include Purchase Orders, Invoices and Bills of Lading.

UN/EDIFACT—United Nations Electronic Data Interchange For Administration, Commerce and Transport. Messages developed under UN/EDIFACT are intended for both national and international EDI applications. Messages considered suitable for implementation are known as United Nations Standard Messages (UNSM) and are published in UN/EDIFACT Directories.

XSLT—Extensible Stylesheet Language for Transformations. XSLT is used to describe and transform a source XML tree into a result tree which may represent a completely different structure. Transformation options include alternate XML representations, HTML, flat files and PDF.

### DETAILED DESCRIPTION

Applicant has discovered a more effective approach for representing the content of data interchange format messages, such as EDI documents, in a markup language, such as XML. One or more XML documents are created which define an XML data dictionary expressing the human readable metadata of the appropriate EDI standard. The data dictionary can be generated in English or any other language. Accordingly, the human readable metadata of EDI can be incorporated into an XML document expressing the underlying data of an EDI document. The semantics of EDI which enjoy industry-wide consensus, can be retained while at the same time making the resulting XML documents self describing and thus easy to use. Further, the metamodel of EDI can be preserved as will be described below.

A preferred embodiment of the invention provides all of the EDI semantics for transaction sets, segments and elements within a data dictionary made up of XML documents. The data dictionary can be modified and customized to meet company or industry specific trading requirements. This data dictionary-based approach enables the transformation of any EDI message in any version of EDI into an XML representation of the underlying EDI message data. The data dictionary also enables the transformation of XML-based business transactions into EDI syntax.

Once the content of the EDI document is expressed as a well-formed XML document, an extensible stylesheet language (XSL) style sheet may be applied to transform the document into hypertext markup language (HTML) in a known manner for display in a conventional Web Browser. Alternatively, the XML document can be passed directly to another application system. The data dictionary will ensure the XML document is compliant with a well-formed EDI message. In other words, the semantics of the EDI document can be preserved.

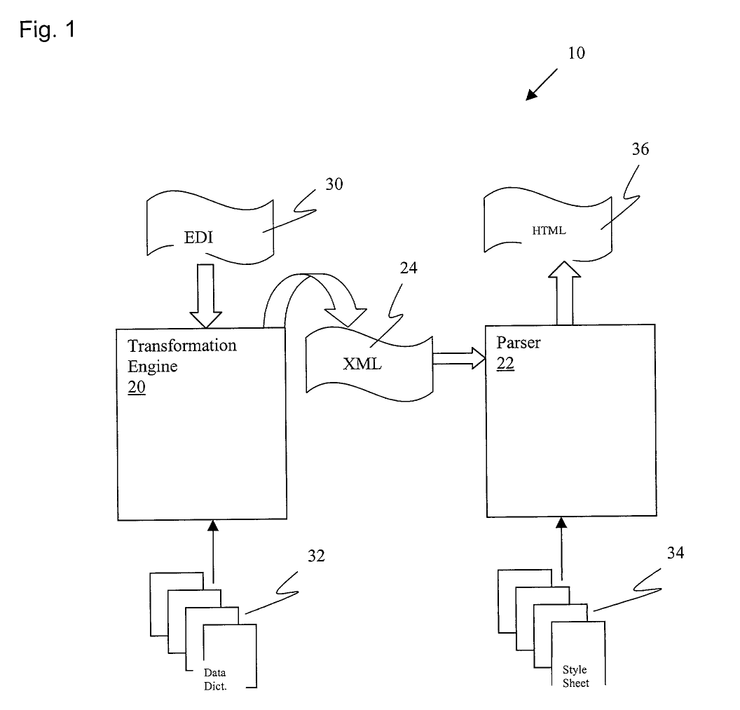

FIG. 1 illustrates data interchange transformation system 10 in accordance with a preferred embodiment of the invention. System 10 can be accomplished through software run on a general purpose programmable computer, such as a personal computer, a server, a network of computers, or other computing devices. The term “computer” as used herein refers to any type of logic device or combination of logic devices capable of being configured to accomplish the functionality described herein.

Transformation engine 20 reads a data interchange document, such as EDI document 30, as input data and transforms the content of EDI document 30 into an XML expression of the content in accordance with data dictionary 32 and logical rules, as described in greater detail below. Data dictionary 32 also is described in greater detail below. Transformation engine 20 outputs XML document 24 as output data. XML document 24 can then be processed by parser 22 or passed directly on to another application or system, such as a purchase order confirmation system. As an example, parser 22 can apply XSL style sheet 34 to XML document 24 to transform the content into HTML for display on the Web.

To better understand the preferred embodiment, an example of expressing the content of an EDI X12 document as an XML document is discussed. Therefore, a brief description of EDI X12 and XML is appropriate.

An EDI X12 message, i.e. document, has a structure consisting of three primary types of pieces, i.e. components; the transaction set, segments, and EDI elements. A transaction set is a collection of segments that form an EDI business document, such as a purchase order. A segment is a group of logically related information and is identified by a two or three digit alpha-numeric code. For example, the N1 (NAME) segment comprises three elements to identify a party, by organization type, name and designation code. Designation codes identify the role of the party identified in the N1 segment, such as “BT” for “BILL TO” and “ST” for “SHIP TO”. It follows that EDI elements are the pieces of data that make up a segment. EDI elements are identified by a one to four digit numerical code and may be used by a plurality of segments. Generally, segments are separated in an EDI document by a hard return and EDI elements are separated by an asterisk. However, other separators can be used. The particular structure of X12 is defined in the current Electronic Data Interchange X12 Standards, the disclosure of which is incorporated herein by reference.

An EDI transaction set is created by logically placing segment and element information together as indicated below:

N1*ST*John Doe

N2*Division 1

N3*1000 Park Avenue

N4*New York City*NY*10610

In the example above, the N1 segment indicates that the ship to party is named “John Doe” and the N2, N3, and N4 segments identify additional names, the street address, and geographic location respectively in accordance with the X12 standard. It can be seen that the standard is very compact. All the metadata has been stripped from the message to compress the data and maximize the limited bandwidth available when the standard was developed. The semantics and metamodel of the EDI standard are defined in external documents.

XML, on the other hand, is a “meta language”—literally a language for defining other languages. While the tags used in an XML document must be organized to conform with certain general principles, the creation and structure of tags and attributes is quite flexible and essentially up to the creator of the document. XML documents must include a special XML processing instruction (PI) in the first line that indicates version of XML, whether the document is standalone (an XML document can be an aggregation of other documents) and any encoding options (for supporting alternate character sets and foreign languages). Following the processing instruction, an XML document may include a DOCTYPE declaration or XML Namespace declaration. The DOCTYPE declaration associates the XML document with an information model, created as a Document Type Definition or DTD, while an XML Namespace declaration can associate the XML document with an XML Schema-based information model.

Data values are placed between start and end tags that describe the data value. Attributes may appear within start tags and can be used to further define the meaning of the data embedded within the tags. For example, the portion of an XML document listed below includes an XML element having a descriptive start and end tags called “name” and having a value of “John.” An attribute named “type” is included to help further define the context of the “name” tag (since “name” does not necessarily have to refer to the name of a person). Note that the example listed below does not have an information model associated with it.

<?xml version=“1.0”?>

<name type=“employee”>John</name>

Any XML document can be represented as a tree structure, since all elements within the document must be embedded within a “master” tag (commonly referred to as the “root”). The XML document begins with a “root element” in which all other elements are nested as “child elements.” The phrase “child element” is a relative term, referring to any element nested within another element. The XML tags can be chosen in virtually any manner, and nested in virtually any manner, to describe the data that comprises the actual document. Therefore, there are a myriad of ways of expressing the same content, whether it be from an EDI document or other source, in an XML document. The preferred embodiment, yields XML documents expressing the same underlying data as a corresponding EDI document while retaining the structure and semantics of the EDI document. As noted above, previous attempts to develop an XML representation of EDI have been unsuccessful due to the volume of transactions and data fields available within EDI (there are over 3,000 business transactions available within all versions of EDI, each of these transactions may contain over 300 different fields).

In a first example of the preferred embodiment, transformation engine 20 is configured, via software in the preferred embodiment, to create a root XML element named “transactionSet”, which corresponds to the EDI transaction set. Further, transformation engine 20 will create child XML elements of the transactionSet element named “segment” correspond to the various EDI segments. In turn, the XML elements named “segment” will contain child XML elements named “element” corresponding to the various EDI elements. These three XML elements, “transactionSet”, “segment”, and “element”, are the major pieces of XML document 24 created by transformation engine 20. The values for each XML element are populated with descriptions of the EDI data based on data dictionary 32 which includes EDI segments and elements and corresponding human readable descriptions as described below. In turn, the corresponding EDI segment data values are placed as a child element between XML tags called “value.” By transforming the three EDI X12 pieces, i.e. transaction set, segment, and EDI element, into XML elements having tags of the corresponding names and by placing descriptions of the EDI data as values of the XML elements, the semantics and structure of EDI document 30 are preserved in XML document 24.

Data dictionary 32 of the first example is an XML document, or a set of XML documents, expressing the semantics of the EDI standard in an XML format and correlating descriptive values of the X12 standard to various EDI segment codes. An example of a portion of data dictionary 32 is found below. It can be seen that, among other things, this example of data dictionary 32 assigns the descriptive value “Currency” to EDI segment code “CUR.” Notice that the segment code itself is assigned as an attribute (called “code”) of the “segment” tag in the data dictionary.

```
<?xml version“1.0”?>
<!DOCTYPE segment SYSTEM “http://www.xyzc.com/dtd/x12dd.dtd”>
<transactionSet code=“840” lang “EN”>
    <segment code=“ST”>Transaction Set Header</segment>
    <segment code=“BQT”>Beginning Segment for Request For
Quotation</segment>
    <segment code=“NTE”>Note/Special Instruction</segment>
    <segment code“CUR”>Currency</segment>
    <segment code=“REF”>Reference Numbers</segment>
    <segment code“PER”>Administrative Communications
```

When designing an XML document, one design choice is whether a piece of information should be an XML attribute or an XML element. In the preferred embodiment, two conditional qualifications are used to resolve this design choice for creating data dictionary 32. If either of the conditions is satisfied, then the piece of information should be set as an element. If not, the piece of information is set as an attribute. The first condition is whether it is possible to have more than one of these pieces of information. A version number will ordinarily be handled as an attribute, just as the XML declaration does. However, if it is possible that the data could support more than one version, then the version will be handled as an element.

The second condition is whether the piece of information is human readable text that is likely to be displayed. A good example is currency. The EDI code “CAD” could be displayed, but not likely. The phrase “Canadian Dollars,” however, has one primary purpose: to be displayed and read by English-speaking users. Thus, “CAD” will be set as an attribute in XML document 24 but “Canadian Dollars” will be set as the content of an element.

Transformation engine 20 of the first example of the preferred embodiment uses only a small number of XML element names, i.e. tags such as “transactionSet”, “segment”, “element”, “value” and name. All other information from an EDI document is expressed as the contents or attributes of these elements. Each of the three major pieces of an EDI document (transaction set, segment, and element), when expressed as an XML document created by transformation engine 20, has an attribute called “code” which contains the corresponding EDI identifier. The major pieces also have a child element called “name” which contains the human readable name for that piece and a child element called “value” which contains the value for that piece.

For example, an EDI 850 transaction set is a purchase order. In the resulting XML document 24, the value of the transaction set attribute called “code” for this transaction set will be “850” and the value of its child element called “name” will be “Purchase Order.” Similarly, EDI segment type “NTE” is a note. The value of corresponding XML segment attribute “code” will be set to “NTE” and its child XML element “name” will have a value of “Note.” Keep in mind that the correlation between the EDI codes and the descriptive metadata is expressed by data dictionary 32. A small portion of the XML document 24 created by transformation engine 20 is below.

```
<transactionSet code”850”>
    <name>Purchase Order</name>
    ...
    <segment code=”NTE”>
        <name>Note</name>
    </segment>
    ...
</transactionSet>
```

As noted above, the underlying data of an EDI message is contained within the EDI elements. There can be many different values for each EDI code. Transformation engine 20 captures both the human-readable and machine-readable representations of the EDI element. This is accomplished using the above-noted XML element “value.” The attribute “code” of the XML element “value” contains the abbreviated EDI code and the contents of the XML element value contain the human readable description of the EDI code. An example is set forth below.

```
<element code=“98”>
    <name>Entity Identifier Code</name>
    <value code=“ST”>Ship To</value>
</element>
```

When EDI elements are populated with free form text or other data, transformation engine 20 populates the XML element “value” with the text or other data. For example “John Doe” would be considered free form text and would be represented in XML document 24 in the following manner:

```
<element code=“93”>
    <name>Name</name>
    <value>John Doe</value>
</element>
```

Transformation engine 20 of the first example employs the above-noted conventions and rules to create XML document 24. As a further example of processing by transformation engine 20, portions of an example of EDI X12 document 30 and corresponding portions of XML document 24 created in accordance with the first example are listed below.

Portion of X12 850 MESSAGE

ST*850 . . .

N1*ST*John Doe . . .

SE*3

Portion of Corresponding XML Document

```
<transactionSet code=“850”>
    <name>Purchase Order</name>
    <segment code=“ST”>
    <name>Transaction Set Header</name>
    <element code=“143”>
        <name>Transaction Set Identifier Code</name>
        <value code=“850”>Purchase Order</value>
    </element>
    </segment>
...
    <segment code=“N1”>
        <name>Name</name>
        <element code=“98”>
            <name>Entity Identifier Code</name>
            <value code=“ST”>Ship To</value>
        </element>
        <element code=“93”>
```

<name>Name</name>
<value>John Doe</value>

</element>

</segment>

...

<segment code=“SE”>

<name>Transaction Set Trailer</name>
<element code=“96”>

<name>Number of Included Segments</name>
<value>3</value>

</element>

</segment>

</transactionSet>

The first example uses only a handful of XML element names such as “transactionSet”, “segment”, “element”, “value” and “name.” All other information can be conveyed as the attributes or contents of these XML elements.

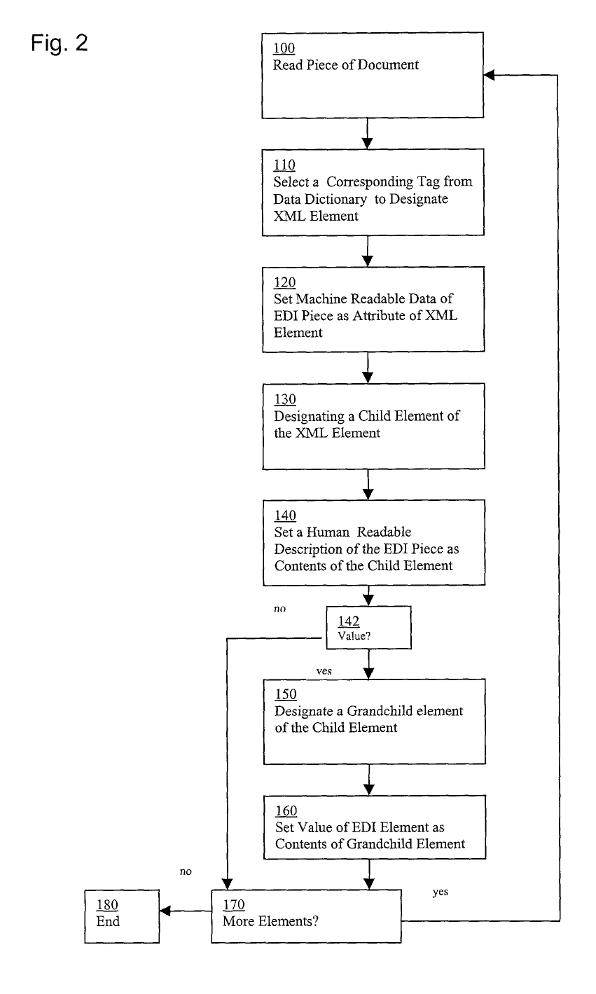

FIG. 2 is a flowchart illustrating a transformation method of transformation engine 20 in accordance with the first example of the preferred embodiment. EDI document 30 is used as input data into transformation engine 20. EDI document 30 can be input in any known manner, such as element by element, in its entirety and stored in a memory, or input in any other manner. In step 100 a piece of EDI document 100 is read by transformation engine 20. In step 110, a tag corresponding to the piece read in step 100 is selected from data dictionary 32 and used to designate an XML element in XML document 24. For example, if the piece read in step 100 is a transaction set header, such as “ST*850”, the EDI tag “transactionSet” will be selected and used as a tag for the corresponding XML element in XML document 24. A transaction set header, or any other piece or portion of EDI document 30 can be distinguished in a known manner in accordance with the appropriate EDI standard.

In step 120, machine readable data of the piece is set as an attribute of the XML element. For example, if EDI document 30 is an 850 purchase order, the machine readable portion of the transaction set header is “850” which will be set as an attribute “code=850” in the XML element. In step 130, a child element of the XML element is set to further describe the XML element by adding a human readable description. The tag “name” of the child element is “name” in the preferred embodiment. Keep in mind that “child element” is a relative term and thus in this case refers to an element nested in the XML element set in step 110. In step 140, a human readable description of the XML element is set as the contents of the “name” element by being placed between start and end “name” tags. The description is chosen based on data dictionary 32 which correlates EDI codes to human-readable metadata as set forth above. Transformation engine 20 then decides if the EDI element has any value data in step 142. If not, the process proceeds to step 170 described below. If the EDI element does have value data, the process proceeds to step 150 in which a child element of the child element, i.e. a grandchild element, is designated. The tag name of the grandchild element is “value” in the preferred embodiment to permit a human to recognize data between the XML tags as a value. In step 160, the value of the EDI element is set as the contents of the value element, i.e. is set between the start and end “value” tags. In step 170, transformation engine 20 determines if there are more EDI pieces to be processed. If not, the process ends in step 180. If there are more pieces to be processed. The process returns to step 100 and continues as described above.

By preserving the existing EDI semantics and structure, the first preferred embodiment allows EDI programmers to leverage what they have learned and used in the past while providing a human readable version of X12. Further, the preferred embodiment is flexible enough to support multiple human readable languages and any display value can have multiple instances in plural languages, and can support as many languages as needed merely by duplicating the “value” element with different attributes and contents. For example, the following portion of a document expresses the value for the EDI code “DEL” in English and French.

```
<element code=”363”>
    <value code=”DEL” lang=”EN”>delivery</value>
    <value code=”DEL” lang=”FR”>livraison</value>
</element>
```

Note that the language abbreviations used above are the ISO standard two-letter abbreviations. However, any appropriate abbreviations can be used. Also, the actual element can easily be adapted to any language because there are only a small amount of tags that need to be translated and such translation, if desired, can be easily accomplished through an XSL transformation by parser 22 in a known manner. The following XSL stylesheet 34 would translate English tags to French tags.

```
<?xml version=”1.0”?>
<style-sheet>
    <template match=”element”>
        <element name=”élément”>
        <attribute name=”genre”><value-of
select=”@type”/></attribute>
    <apply-templates/>
        </element>
    </template>
    <template match=”value”>
        <element name=”valeur”>
        <attribute name=”code”><value-of
select=”@code”/></attribute>
        <attribute name=”langue”><value-of
select=”@lang”/></attribute>
        <value-of/>
        </element>
    </template>
</xsl:style-sheet>
```

Transformation engine 20 of a second example of the preferred embodiment is configured, via software, to create a root XML element named “Transaction_XXX” where XXX corresponds to the EDI name of the appropriate business transaction (such as 850—an X12 Purchase Order). Further, transformation engine 20 will create child XML elements of the Transaction_XXX element named “Segment_XXX” or Element_XXX (where XXX represents to the various EDI segment or element types, such as an ISA segment (Interchange Control Header) or 330 element (Quantity Ordered). A special EDI construct, known as a “Loop” is used to represent potentially repeating data structures. This transformation preserves these special constructs using elements named “Loop_XXX” (where XXX represents the type of EDI Loop being represented, such as a PID—Product/Item Description line item within a Purchase Order). A Transaction element may contain multiple Segment or Loop elements, each of which may contain one or more Elements. A sample XML representation of an X12 Purchase Order appears in the Appendix attached hereto. These four XML elements, “Transaction_XXX”, “Segment_XXX”, “Element_XXX” and “Loop_XXX”, are the major pieces of XML document 24 created by transformation engine 20. The values for the XML tags and description attributes are populated from the EDI metadata in data dictionary 32. The data dictionary consists of several XML files that describe the structures of the EDI segments and elements for a given EDI transaction. Data dictionary 32 also includes the corresponding human readable metadata for the contents of each EDI transaction, segment and EDI element. By transforming the EDI components, i.e. transaction set, segment, EDI element and loop, into XML elements having tags of the corresponding names and by placing descriptions of the EDI data as attributes of the XML elements, the semantics and structure of EDI document 30 are preserved in XML document 24 when applying the second example.

Data dictionary 32 of the second example is a set of XML documents expressing the semantics of the EDI standard in an XML format and correlating descriptive values to various EDI segment codes. An example of a portion of data dictionary 32 of the second example is found below. It can be seen that, among other things, this example of data dictionary 32 associates the descriptive value “Transaction Set Header” with EDI segment code “ST.” Notice that the segment code is included as an attribute (called “code”) of the “segmentRef” tag in the data dictionary.

```
<?xml version=“1.0”?>
<!--Copyright (c) 2001 XMLSolutions Corporation. All rights reserved.-->
<transactionSet code=“850” functionalID=“PO” lang=“EN”>
    <name>Purchase Order</name>
    <version>004040</version>
    <segmentRef code=“ST” req=“M” maxOccurence=“1”
href=“S_ST.xml”>Transaction Set Header</segmentRef>
    <segmentRef code=“BEG” req=“M” maxOccurence=“1”
href=“S_BEG.xml”>Beginning Segment for Purchase
        Order</segmentRef>
    <segmentRef code=“CUR” req=“O” maxOccurence=“1”
href=“S_CUR.xml”>Currency</segmentRef>
    <segmentRef code=“REF” req=“O” maxOccurence=“>1”
href=“S_REF.xml”>Reference Identification.</segmentRef>
    <segmentRef code=“PER” req=“O” maxOccurence=“3”
href=“S_PER.xml”>Administrative Communications
        Contact</segmentRef>
    <segmentRef code=“TAX” req=“O” maxOccurence=“>1”
href=“S_TAX.xml”>Tax Reference</segmentRef>
    <segmentRef code=“FOB” req=“O” maxOccurence=“>1”
href=“S_FOB.xml”>F.O.B. Related Instructions</segmentRef>
    <segmentRef code=“CTP” req=“O” maxOccurence=“>1”
href=“S_CTP.xml”>Pricing Information</segmentRef>
    <segmentRef code=“PAM” req=“O” maxOccurence=“10”
href=“S_PAM.xml”>Period Amount</segmentRef>
    <segmentRef code=“CSH” req=“O” maxOccurence=“5”
href=“S_CSH.xml”>Sales Requirements</segmentRef>
    <segmentRef code=“TC2” req=“O” maxOccurence=“>1”
href=“S_TC2.xml”>Commodity</segmentRef>
    <loop code“SAC” req=“O” maxOccurence=“25”>
        <segmentRef code=“SAC” req=“O” maxOccurence=“1”
    href=“S_SAC.xml”>Service, Promotion, Allowance, or
                    Charge Information</segmentRef>
        <segmentRef code“CUR” req=“O” maxOccurence=“1”
href=“S_CUR.xml”>Currency</segmentRef>
    </loop>
...
</transaction Set>
```

Transformation engine 20 in accordance with the second example also uses only a small number of XML element names, i.e. tags such as “Transaction_XXX”, “Segment_XXX”, “Loop_XXX”, and “Element_XXX”. All other information from an EDI document is expressed as the contents or attributes of these elements. Each of the four major pieces of an EDI document (i.e., transaction set, segments, loops and elements), when expressed as an XML document created by transformation engine 20, has an attribute called “desc” which contains the corresponding EDI description, i.e. medata.

For example, an EDI 850 transaction set is a purchase order. In the resulting XML document 24, the name of the root level element is “Transaction_{—}850” with the “desc” attribute set to “Purchase Order” (note that the Transaction_XXX element includes a special attribute “version” to communicate which version of the EDI standard is being represented). Similarly, “Element_{—}324” represents a Purchase Order Number, causing the associated “desc” attribute to be set to the appropriate description (see below). Keep in mind that the correlation between the EDI codes and the descriptive metadata is expressed by data dictionary 32. This approach enables the Transaction Sets, Segments, EDI Elements and Loops to be modified to comply with a particular trading partner's implementation guidelines. A small portion of the XML document 24 created by transformation engine 20 in accordance with the second example is set forth below.

<Transaction_850 desc=“Purchase Order” version=“003040”> . . .

<Element_324 desc=“Purchase Order Number”>XX-1234</Element_324> . . .

</Transaction_850>

As noted above, the underlying data of an EDI message is contained within the EDI elements. There can be many different values for each EDI code. Transformation engine 20 captures both the human-readable and machine-readable representations of the EDI element. This is accomplished in the second example using the name of the tag, e.g. “Element_{—}324”, the “desc” attribute and the actual value embedded within the XML element.

When EDI elements are populated with free form text or other data, transformation engine 20 in accordance with the second example populates the contents of the XML element with the text or other data, while the “desc” attribute is set to the corresponding name from the EDI standard ascertained from data dictionary 32. For example “John Doe” would be considered free form text and would be represented in XML document 24 in the following manner:

<Element_93 desc=“Name”>John Doe</Element_93>

Transformation engine 20 employs the above-noted conventions and rules to create XML document 24. As a further example of processing by transformation engine 20 in accordance with the second example, portions of an example of EDI X12 document 30 and corresponding portions of XML document 24 are listed below.

Portion of X12 850 Message

ST*850 . . .

N1*ST*John Doe . . .

SE*3

Portion of Corresponding XML Document

```
<?xml version=“1.0” encoding=“UTF-8”?>
<Transaction_850 desc=“Purchase Order” version=“003040”>
...
<Segment_ST desc=“Transaction Set Header”>
<Element_143 desc=“Transaction Set Identifier Code”
    valueDesc=“X12.1 Purchase Order”>850</Element_143>
<Element_329 desc=“Transaction Set Control
Number”>0001</Element_329>
</Segment_ST>
...
...
<Loop_N1>
    <Segment_N1 desc=“Name”>
        <Element_98 desc=“Entity Identifier Code”
            valueDesc=“Bill-to-Party”>BT</Element_98>
    <Element_93 desc=“Name”>FRIENDLY AIRLINES</Element_93>
  <Element_67 desc=“Identification
  Code”>123456789-0101</Element_67>
  </Segment_N1>
  <Segment_N2 desc=“Additional Name Information”>
    <Element_93 desc=“Name”> ACCOUNTING
    DIVISION</Element_93>
  </Segment_N2>
  <Segment_N3 desc=“Address Information”>
  <Element_166 desc=“Address Information”>123 MAIN
  ST.</Element_166>
  </Segment_N3>
  <Segment_N4 desc=“Geographic Location”>
    <Element_19 desc=“City Name”>PITTSBURGH </Element_19>
    <Element_156 desc=“State or Province Code”>PA</Element_156>
    <Element_116 desc=“Postal Code”>15122</Element_116>
    <Element_26 desc=“Country Code”>US</Element_26>
  <Segment_N4>
  </Loop_N1>
...
<Segment_SE desc=“Transaction Set Trailer”>
    <Element_96 desc=“Number of Included
    Segments”>26</Element_96>
    <Element_329 desc=“Transaction Set Control
Number”>0001<Element_329>
</Segment_SE>
...
</Transaction_850>
```

It can be seen that the XML expression of the EDI document content created by transformation engine 20 of the second example is also relatively verbose. However, this is not a significant issue. Further, XML, unlike EDI, is easily readable by both humans and machines. The preferred embodiment leverages existing EDI semantics and structures while presenting an approach for creating an XML document. The second example of the preferred embodiment uses only a handful of XML element names such as “Transaction_XXX”, “Segment_XXX”, “Element_XXX”, and “Loop_XXX”. All other information can be conveyed as the attributes or contents of these XML elements.

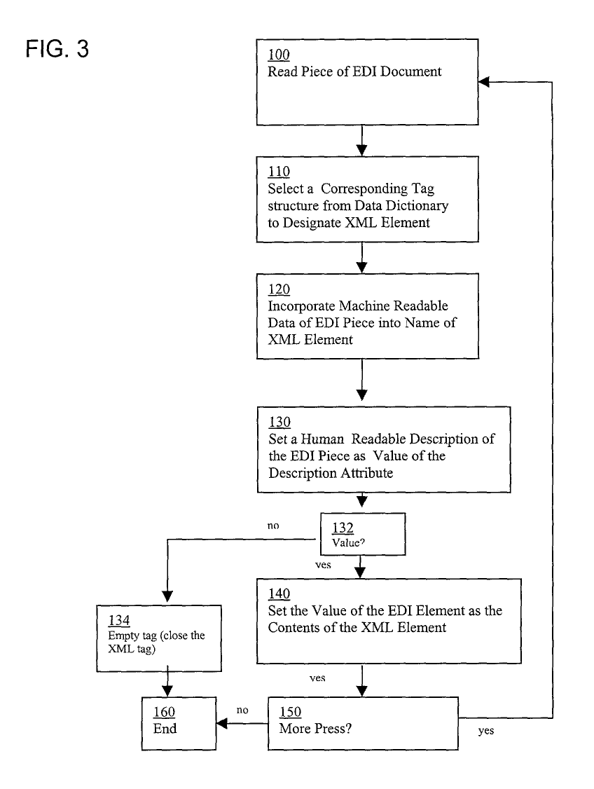

FIG. 3 is a flowchart illustrating a transformation method of transformation engine 20 in accordance with the preferred embodiment. EDI document 30 is used as input data into transformation engine 20. EDI document 30 can be input in any known manner, such as element by element, in its entirety and stored in a memory, or input in any other manner. In step 100 a piece of EDI document 100 is read by transformation engine 20. In step 110, a tag structure corresponding to the piece read in step 100 is selected from data dictionary 32, in the manner described above, and used to designate an XML element in XML document 24. For example, if the piece read in step 100 is a transaction set header, such as “ST*850”, the tag structure “Transaction_” will be selected and used as a tag for the corresponding XML element in XML document 24. A transaction set header, or any other piece or portion of EDI document 30 can be distinguished in a known manner in accordance with the appropriate EDI standard.

In step 120, the machine readable DEI code is incorporated into the tag structure to create the XML element name, such as “Transaction_{—}850.” In step 130, machine readable data of the piece is used to determine human readable metadata to be set as an attribute of the XML element. The determination is made by referencing the metadata corresponding to the machine readable code in data dictionary 32. For example, if EDI document 30 is an 850 purchase order, the machine readable portion of the transaction set header is “850” which will cause the “desc” attribute of the XML element to be set to “Purchase Order” (the corresponding version attribute will also be set—e.g. version=“004030”). Note that “Purchase Order” is the metadata corresponding to the EDI code 850 in the EDI X12 Standard. The description is chosen based on data dictionary 32 which correlates EDI codes to human-readable metadata as set forth above. Transformation engine 20 decides if the EDI element has any value data in step 132. If not, the process proceeds to step 134 in which the XML element is closed with an end tag. If the EDI element does have value data, the process proceeds to step 140 in which the value of the EDI element is set as the contents of the element, i.e., is set between the start and end XML tags. In step 150, transformation engine 20 determines if there are more EDI pieces to be processed. If not, the process ends in step 160. If there are more pieces to be processed. The process returns to step 100 and continues as described above.

Note that the process is used to create XML document 24. A separate, process can be utilized to create data dictionary 32. Data dictionaries 32 are XML expressions of the underlying data of X12 and EDIFACT data dictionaries. Each data dictionary 32 defines the structure of all EDI transaction sets that are based on a particular version of an EDI data format (e.g. 4010, 4020, 4030). Each data dictionary also defines the structure of all data segments and data elements that are used by each of those transaction sets. Since a given element might be used by more than one segment and a given segment might be used by more than one transaction set, the data dictionaries 32 describe a network of relationships between the various segments and elements that make up an EDI document. They also indicate whether segments and elements are mandatory or optional within each transaction set.

In the preferred embodiment, the definition for each transaction set, segment, and element in a data dictionary is stored in its own XML document and can be referenced by multiple parent items. For example, the definitions of a Purchase Order segment and an Invoice segment might link to the same definition of a Shipping Address element. Consequently, when the EDI parser determines that it needs the data dictionary for a given transaction set, it typically reads a number of documents to load the entire data dictionary definition. Each data dictionary 32 contains the XML documents that specify the details thereof. There can be a separate XML document for each transaction set, segment, and element that is defined by the EDI standards. External links are indicated by segment and element references. Anywhere a segment or an element would appear in one document of data dictionary 32, a reference appears instead. The reference specifies the URL, or other link or pointer, of the XML file that contains the definition of that segment or element. The URLs are relative to the root directory of data dictionary 32. A portion of the 850 Purchase Order Transaction Set Data Dictionary appears below:

```
<?xml version“1.0”?>
<!--Copyright (c) 2001 XMLSolutions Corporation. All rights reserved.-->
<transactionSet code=“850” functionalID=“PO” lang=“EN”>
    <name>Purchase Order</name>
    <version>004030</version>
    <segmentRef code=“ST” req=“M” maxOccurence=“1”
href=“S_ST.xml”>Transaction Set Header</segmentRef>
    <segmentRef code=“BEG” req=“M” maxOccurence=“1”
href=“S_BEG.xml”>Beginning Segment for Purchase
    Order</segmentRef>
    <segmentRef code=“CUR” req=“O” maxOccurence=“1”
href=“S_CUR.xml”>Currency</segmentRef>
    <segmentRef code=“REF” req=“O” maxOccurence=“>1”
href=“S_REF.xml”>Reference Identification</segmentRef>
    <segmentRef code=“PER” req=“O” maxOccurence=“3”
href=“S_PER.xml”>Administrative Communications
    Contact</segmentRef>
    <segmentRef code=“TAX” req=“O” maxOccurence=“>1”
href=“S_TAX.xml”>Tax Reference</segmentRef>
    <segmentRef code=“FOB” req=“O” maxOccurence=“>1”
href=“S_FOB.xml”>F.O.B. Related Instructions</segmentRef>
    <segmentRef code=“CTP” req=“O” maxOccurence=“>1”
href=“S_CTP.xml”>Pricing Information</segmentRef>
    <segmentRef code=“PAM” req=“O” maxOccurence=“10”
href=“S_PAM.xml”>Period Amount</segmentRef>
    <segmentRef code=“CSH” req=“O” maxOccurrence=“5”
href=“S_CSH.xml”>Sales Requirements</segmentRef>
    <segmentRef code=“TC2” req=“O” maxOccurence=“>1”
href=“S_TC2.xml”>Commodity</SegmentRef>
...
</transactionSet>
```

The data dictionaries 32 can express a number of different EDI standard libraries such those available from ASC X12 and UN/EDIFACT. SEF (Standard Exchange Format) EDI guidelines are connected into the expected data dictionary format discussed above. In the second example above, standard EDI codes are embedded within the actual XML tag names (e.g. “Element_{—}373 ”—where “373” is the standard EDI code), while attributes are utilized to communicate the human readable text describing the meaning of the elements. An example of this approach appears below:

<Element_373 desc=“Date”>010628</Element_373>

Accordingly, computers can read the codes and display the text for humans. By using both well-known EDI codes and the corresponding human-readable values, information models and style sheets become easier to write and maintain for both EDI and XML experts. Furthermore, the preferred embodiment makes the meaning and purpose of data in the resulting XML document obvious to a human without having to refer to an external standard, such as the EDIFACT or X12 standard.

Further, the second example also is flexible enough to support multiple human readable languages since the value of the EDI element is separated from the EDI code itself. For example, an Interchange Control Number can be easily expressed in both English and French:.

English:

<Element_I12 desc=“Interchange Control Number”>

987654321

</Element_I12>

French:

<Element_I12 desc=“Nombre De Commande D'Échange”>

987654321

</Element_I12>

Note that the French example utilizes attribute values that would be considered invalid using the standard UTF 8 or UTF-16 encoding format. The French example utilizes either Unicode or an alternative encoding option (ISO-8859-1) to avoid an XML parser error. Note that the preferred embodiment also supports mixed language representations (e.g. XML tags and attributes in English, while the values inside the tags are French).

The preferred embodiment allows companies to customize their XML documents to match the idiosyncrasies of their EDI approach. Data dictionary 32 can be modified and customized to meet specific requirements, for example company requirements or industry specific trading requirements. Also, since the definitions of each transaction set, segment, and element are contained in separate XML documents, a change to a piece of the transaction set need only be effected once to be effective throughout the transaction set The preferred embodiment allows modification of XML documents using the same information model, making it easy to integrate with trading partners who have different requirements.

By preserving the existing EDI semantics and structure, the preferred embodiment allows EDI programmers to leverage what they have learned and used in the past while providing a human readable version of EDI. The use of the data dictionary allows construction of XML elements containing both the unique EDI codes and descriptive human readable metadata that is semantically correct. The EDI codes and the metadata can be incorporated into the XML element in any manner. For example, the element can be comprised of an XML tag having a name that is identical to the EDI metadata with the corresponding EDI code being set as an attribute.

The invention can be implemented on any device, such as a general purpose programmable computer or a hardwired logic device. The invention can utilize plural devices, such as a network of computers, and communication can be accomplished through any channel, such as a local area network (LAN), the Internet, serial communications ports, and the like. The communications channels can use wireless technology, such as radio frequency or infra-red technology. The various elements of the preferred embodiment are segregated by function for the purpose of clarity. However, the various components can be combined into one device or segregated in a different manner. For example, software can be a single executable file and data files, or plural files or modules stored on the same device or on different devices. The invention can be used to transform the information for any expression of information having data and metadata into another expression of the information. For example, the invention can transform EDI X12 or EDI EDIFACT documents into XML documents.

The invention has been described through a preferred embodiment. However, various modifications can be made without departing from the scope of the invention as defined by the appended claims and legal equivalents thereof.

APPENDIX

<?xml version=“1.0” encoding“UTF 8”?>
<Transaction_850 desc=“Purchase Order” version=“003040”>

<Segment_ISA desc=“Interchange Control Header”>

<Element_I01 desc=“Authorization Information Qualifier” valueDesc=“No Authorization Information Present (No

Meaningful Information in I02)”>00</Element_I01>

<Element_I02 desc=“Authorization Information”> </Element_I02>
<Element_I03 desc=“Security Information Qualifier” valueDesc=“No Security Information Present (No

Meaningful Information in I04)”>00</Element_I03>

<Element_I04 desc=“Security Information”> </Element_I04>
<Element_I05 desc=“Interchange ID Qualifier” valueDesc“Mutually Defined”>ZZ</Element_I05>
<Element_I06 desc=“Interchange Sender ID”>31 05451234 </Element_I06>
<Element_I05 desc=“Interchange ID Qualifier” valueDesc=“Mutually Defined”>ZZ</Element_I05>
<Element_I07 desc=“Interchange Receiver ID”>XYZ Inc </Element_I07>
<Element_I08 desc=“Interchange Date”>920703</Element_I08>
<Element_I09 desc=“Interchange Time”>1604</Element_I09>
<Element_I10 desc=“Interchange Control Standards Identifier” valueDesc=“U.S. EDI Community of ASC X12,

TDCC, and UCS”>U</Element_I10>

<Element_I11 desc=“Interchange Control Version Number” valueDesc=“Draft Standard for Trial Use Approved

for Publication by ASC X12 Procedures Review Board Through October 1990>00301</Element_I11>

<Element_I12 desc=“Interchange Control Number”>987654321</Element_I12>
<Element_I13 desc=“Acknowledgment Requested” valueDesc“Interchange Acknowledgment

Requested”>1 </Element_I13>

<Element_I14 desc=“Test Indicator” valueDesc=“Test Data”>T</Element_I14>
<Element_I15 desc=“Subelement Separator”>&gt;</Element_I15>

</Segment ISA>
<Segment_GS desc=“Functional Group Header”>

<Element_479 desc=“Functional Identifier Code” valueDesc=“Purchase Order (850)”>PO</Element_479>
<Element_142 desc=“Application Sender&apos;s Code”>ABC Co</Element_142>
<Element_124 desc=“Application Receiver&apos;s Code”>XYZ Inc</Element_124>
<Element_373 desc=“Date”>927003</Element_373>
<Element_337 desc=“Time”>1203</Element_337>
<Element_28 desc=“Group Control Number”>1112</Element_28>
<Element_455 desc=“Responsible Agency Code” valueDesc=“Transportation Data Coordinating Committee

(TDCC)”>T</Element_455>

<Element_480 desc=“Version / Release / Industry Identifier Code” valueDesc=“Draft Standards Approved for

Publication by ASC X12 Procedures Review Board through October 1993>003040</Element_480>

</Segment_GS>
<Segment_ST desc=“Transaction Set Header”>

<Element_143 desc=“Transaction Set Identifier Code” valueDesc”X12.1 Purchase

Order”>850</Element_143>

<Element_329 desc=“Transaction Set Control Number”>0001</Element_329>

</Segment_ST>
<Segment_BEG desc=“Beginning Segment for Purchase Order”>

<Element_353 desc=“Transaction Set Purpose Code” valueDesc=“Original”>00</Element_353>
<Element_92 desc=“Purchase Order Type Code” valueDesc”Stand-alone Order”>SA</Element_92>
<Element_324 desc=“Purchase Order Number”>XX-1234</Element_324>
<Element_328 desc=“Release Number”/>
<Element_323 desc=“Purchase Order Date”>19980301</Element_323>
<Element_367 desc=“Contract Number”>AE123</Element_367>

</Segment_BEG>
<Segment_PER desc=“Administrative “Communications Contact”>

<Element_366 desc=“Contact Function Code” valueDesc=“Buyer Name or Department”>BD</Element_366>
<Element_93 desc=“Name”>ED SMITH</Element_93>
<Element_365 desc=“Communication Number Qualifier” valueDesc=“Telephone”>TE</Element_365>
<Element_364 desc=“Communication Number”>800-123-4567</Element_364>

</Segment_PER>
<Segment_TAX desc=“Tax Reference”>

<Element_325 desc=“Tax Identification Number”>53247765</Element_325>
<Element_309 desc=“Location Qualifier” valueDesc=“State/Province”>SP</Element_309>
<Element_310 desc=“Location Identifier”>CA</Element_310>
<Element_309 desc=“Location Qualifier” valueDesc=“”/>
<Element_310 desc=“Location Identifier”/>
<Element_309 desc=“Location Qualifier” valueDesc=“”/>
<Element_310 desc=Location Identifier”/>
<Element_309 desc=Location Qualifier” valueDesc=“”/>
<Element_310 desc=“Location Identifier”/>
<Element_309 desc=“Location Qualifier” valueDesc=“”/>
<Element_310 desc=“Location Identifier”/>
<Element_441 desc=“Tax Exempt Code” valueDesc=“Exempt (Per State Law)”>9</Element_441>

</Segment_TAX>
<Segment_FOB desc=“F.O.B. Related Instructions”>

<Element_146 desc=“Shipment Method of Payment” valueDesc=“Prepaid (by Seller)”>PP</Element_146>
<Element_309 desc=“Location Qualifier” valueDesc=“Origin (Shipping Point)”>OR</Element_309>
<Element_352 desc=“Description”>DALLAS TX</Element_352>

</Segment_FOB>
<Segment_ITD desc=“Terms of Sale/Deferred Terms of Sale”>

<Element_336 desc=“Terms Type Code” valueDesc=“Basic”>01</Element_336>
<Element_333 desc=“Terms Basis Date Code” valueDesc=“Invoice Date”>3</Element_333>
<Element_338 desc=“Terms Discount Percent”>5</Element_338>
<Element_370 desc=“Terms Discount Due Date”/>
<Element_351 desc=“Terms Discount Days Due”>10</Element_351>
<Element_446 desc=“Terms Net Due Date”/>
<Element_386 desc=“Terms Net Days”>30</Element_386>
<Element_362 desc=“Terms Discount Amount”/>
<Element_388 desc=“Terms Deferred Due Date”/>
<Element_389 desc=“Deferred Amount Due”/>
<Element_342 desc=“Percent of Invoice Payable”/>
<Element_352 desc=“Description”/>
<Element_765 desc=“Day of Month”/>
<Element_107 desc=“Payment Method Code” valueDesc=“Electronic Payment System”>E</Element_107>

</Segment_ITD>
<Loop_N1>
<Segment_NI desc=“Name”>

<Element_98 desc=“Entity Identifier Code” valueDesc=“Bill-to-Party”>BT</Element_98>

<Element_93 desc=“Name”>FRIENDLY AIRLINES</Element_93>
<Element_66 desc=“Identification Code Qualifier” valueDesc=“D-U-N-S+4, D-U-N-S Number with Four

Character Suffix”>9</Element_66>

<Element_67 desc=“Identification Code”>123456789-0101</Element_67>

</Segment_N1>
<Segment_N2 desc=“Additional Name Information”>

<Element_93 desc=“Name”>ACCOUNTING DIVISION</Element_93>

</Segment_N2>
<Segment N3 desc=“Address Information”>

<Element_166 desc=“Address Information”>12 DUCKETS ST.</Element_166>

</Segment_N3>
<Segment_N4 desc=“Geographic Location”>

<Element_19 desc=“City Name”>POOR TOWN </Element_19>
<Element_156 desc=“State or Province Code”>CA</Element_156>
<Element_116 desc=“Postal Code”>98007</Element_116>
<Element_26 desc=“Country Code”>US</Element_26>

</Segment_N4>

</Loop_N1>
<Loop_N1>

<Segment_N1 desc=“Name”>

<Element_98 desc=“Entity Identifier Code” valueDesc=“Ship To”>ST</Element_98>
<Element_93 desc=“Name”>ABC AEROSPACE</Element_93>
<Element_66 desc=“Identification Code Qualifier” valueDesc=“D-U-N-S+4, D-U-N-S Number with Four

Character Suffix”>9</Element_66>

<Element_67 desc=“Identification Code”>123456789-0101</Element_67>

</Segment_N1>
<Segment_N2 desc=“Additional Name Information”>

<Element_93 desc=“Name”>AIRCRAFT DIVISION</Element_93>

</Segment_N2>
<Segment_N3 desc=“Address Information”>

<Element_166 desc=“Address Information”>1000 JET BLVD.</Element_166>

</Segment_N3>
<Segment_N4 desc=“Geographic Location”>

<Element_19 desc=“City Name”>FIGHTER TOWN </Element_19>
<Element_156 desc=“State or Province Code”>CA</Element_156>
<Element_116 desc=“Postal Code”>98895</Element_116>
<Element_26 desc=“Country Code”>US</Element_26>

</Segment_N4>

</Loop_N1>
<Loop_PO1>

<Segment_PO1 desc=“Baseline Item Data”>

<Element_350 desc=“Assigned Identification”>1 </Element_350>
<Element_330 desc=“Quantity Ordered”>31 </Element_330>
<Element_355 desc=“Unit or Basis for Measurement Code” valueDesc=“Each”>EA</Element_355>
<Element_212 desc=“Unit Price”>17.45</Element_212>
<Element_639 desc=“Basis of “Unit Price Code” valueDesc=“Contract”>CT</Element_639>
<Element_235 desc=“Product/Service ID Qualifier” valueDesc=“Manufacturer&apos;s Part

Number”>MG</Element_235>

<Element_234 desc=“Product/Service ID”>nmB-1234</Element_234>

</Segment_PO1>
<Loop PID>

<Segment_PID desc=“Product/Item Description”>

<Element_349 desc=“Item Description Type” valueDesc=“Free~form”>F</Element_349>
<Element_750 desc=“Product/Process Characteristic Code” valueDesc=“”/>
<Element_559 desc=“Agency Qualifier Code” valueDesc=“”/>
<Element_751 desc=“Product Description Code”/>
<Element_352 desc=“Description”>HAMMER-CLAW</Element_352>

</Segment_PID>

</Loop_PID>

</Loop_PO1>
<Loop_PO1>

<Segment_PO1 desc=“Baseline Item Data”>

<Element_350 desc=“Assigned Identification”>2</Element_350>
<Element_330 desc=“Quantity Ordered”>102</Element_330>
<Element_355 desc=“Unit or Basis for Measurement Code” valueDesc=“Each”>EA</Element_355>
<Element_212 desc=“Unit Price”>33.00</Element_212>
<Element_639 desc=“Basis of “Unit Price Code” valueDesc=“Contract”>CT</Element_639>
<Element_235 desc=“Product/Service ID Qualifier” valueDesc=“Manufacturer&aPos;s Part

Number”>MG</Element_235>

<Element_234 desc=“Product/Service ID”>L505-123</Element_234>

</Segment_PO1>
<Loop_PID>

<Segment_PID desc=“Product/Item Description”>

<Element_349 desc=“Item Description Type” valueDesc=“Free~form”>F</Element_349>
<Element_750 desc=“Product/Process Characteristic Code” valueDesc=“”>
<Element_559 desc=“Agency Qualifier Code” valueDesc=“”/>
<Element_751 desc=“Product Description Code”/>
<Element_352 desc=“Description”>PLIERS 8&quot; - NEEDLE NOSE</Element_352>

</Segment_PID>

</Loop_PID>

</Loop_PO1>
<Loop_PO1>

<Segment_PO1 desc=“Baseline Item Data”>

<Element_350 desc=“Assigned Identification”>3</Element_350>
<Element_330 desc=“Quantity Ordered”>48</Element_330>
<Element_355 desc=“Unit or Basis for Measurement Code” valueDesc=“Each”>EA</Element_355>
<Element_212 desc=“Unit Price”>3</Element_212>
<Element_639 desc=“Basis of “Unit Price Code” valueDesc=“Contract”>CT</Element_639>
<Element_235 desc=“Product/Service ID Qualifier” valueDesc=“Manufacturer&apos;s Part

Number”>MG</Element_235>

<Element_234 desc=“Product/Service ID”>R5656-2</Element_234>
<Element_235 desc=“Product/Service ID Qualifier” valueDesc=“Buyer&apos;s Part

Number”>BP</Element_235>

<Element_234 desc=“Product/Service ID”>AB123-2</Element_234>

</Segment_PO1>
<Loop_PID>

<Segment_PID desc=“Product/Item Description”>

<Element_349 desc=“Item Description Type” valueDesc=“Free-form”>F</Element_349>
<Element_750 desc=“Product/Process Characteristic Code” valueDesc=“”/>
<Element_559 desc=“Agency Qualifier Code” valueDesc=“”/>
<Element_751 desc=“Product Description Code”/>
<Element_352 desc=“Description”>METAL RULER - MACHINIST</Element_352>

</Segment_PID>

</Loop_PID>
<Segment_FOB desc=“F.O.B. Related Instructions”>

<Element_146 desc=“Shipment Method of Payment” valueDesc=“Collect”>CC</Element_146>
<Element_309 desc=“Location Qualifier” valueDesc=“Plant”>PL</Element_309>
<Element_352 desc=“Description”>FIGHTER TOWN</Element_352>
<Element_334 desc=“Transportation Terms Qualifier Code” valueDesc=“”/>
<Element_335 desc=“Transportation Terms Code” valueDesc=“”/>
<Element_309 desc=“Location Qualifier” valueDesc=“”>SE</Element_309>
<Element_352 desc=“Description”>LOADING DOCK</Element_352>

</Segment_FOB>
<Segment_SCH desc=“Line Item Schedule”>

<Element_380 desc=“Quantity”>24</Element_380>
<Element_355 desc=“Unit or Basis for Measurement Code” valueDesc=“Each”>EA</Element_355>
<Element_98 desc=“Entity Identifier Code” valueDesc=“Party to be billed(AAR Accounting Rule

11)”>11</Element_98>

<Element_93 desc=“Name”>Test</Element_93>
<Element_374 desc=“Date/Time Qualifier” valueDesc=“Required By”>1 06</Element_374>
<Element_373 desc=“Date”>19980515</Element_373>

</Segment_SCH>
<Segment_SCH desc=“Line Item Schedule”>
<Element_380 desc=“Quantity”>24</Element_380>
<Element_355 desc=“Unit or Basis for Measurement Code” valueDesc=“Each”>EA</Element_355>
<Element_98 desc=“Entity Identifier Code” valueDesc=“Party to be billed(AAR Accounting Rule

11)”>11</Element_98>

<Element_93 desc=“Name”>Test</Element_93>
<Element_374 desc=“Date/Time Qualifier” valueDesc=“Required By”>106</Element_374>
<Element_373 desc=“Date”>19980615</Element_373>

</Segment_SCH>

</Loop_PO1>
<Segment_CTT desc=“Transaction Totals”>

<Element 354 desc=“Number of Line Items”>3</Element_354>

</Segment_CTT>
<Segment_AMT desc=“Monetary Amount”>

<Element_522 desc=“Amount Qualifier Code” valueDesc=“Total Transaction Amount”>TT</Element_522>
<Element 782 desc=“Monetary Amount”>902.75</Element_782>

</Segment_AMT>
<Segment_SE desc=“Transaction Set Trailer”>

<Element_96 desc=“Number of Included Segments”>26</Element_96>
<Element_329 desc=“Transaction Set Control Number”>0001</Element_329>

</Segment_SE>
<Segment_GE desc=“Functional Group Trailer”>

<Element_97 desc=“Number of Transaction Sets Included”>1</Element_97>
<Element_28 desc=“Group Control Number”>1112</Element_28>

</Segment_GE>
<Segment_IEA desc=“Interchange Control Trailer”>

<Element_I16 desc=“Number of Included Functional Groups”>1</Element_I16>
<Element_I12 desc=“Interchange Control Number”>987654321</Element_I12>

</Segment_IEA>

</Transaction_850>

What is claimed is:

1. A method for expressing the data of an EDI document as an XML document, the method comprising:
(a) reading a piece of the EDI document;
(b) designating an XML element with an XML tag;
(c) setting the EDI code corresponding to the piece as an attribute of the XML element;
(d) designating a child element of the XML element with a child tag
(e) generating a human readable description of the EDI code as the contents of the child element;
(f) if the piece has a corresponding value, designating a grandchild element of the XML element and setting the value as the contents of the grandchild element; and
(g) repeating said steps (a)-(f) for each desired piece of the EDI document; and

2. A method as recited in claim 1, wherein said step (e) comprises generating the human readable description of the EDI code based on the appropriate standard data dictionary corresponding to the EDI document.

3. A method as recited in claim 2, wherein the XML name is selected from one of “transaction set”, “segment”, and “element.”

4. A method as recited in claim 3, wherein the child tag name is “name.”

5. A method as recited in claim 4, wherein the grandchild element is designated by a tag having the name “value.”

6. A method as recited in claim 2, wherein said data dictionary is at least one XML document which correlates EDI codes with the metadata of the appropriate EDI standard.

7. A method for expressing the data of an EDI document as an XML document, the method comprising:
(a) reading a piece of the EDI document;
(b) selecting a tag structure to designate an XML element corresponding to the piece;
(c) incorporating the EDI code of the piece into the tag structure to create an XML tag designating an XML element;
(d) setting a human readable description corresponding to the EDI code as a value of the XML attribute of the XML element;
(e) if the piece has a corresponding value, setting the value of the piece as the contents of the XML element; and
(f) repeating said steps (a) through (e) for each desired piece of the EDI document.

8. A method as recited in claim 1, wherein said step (d) comprises generating the human readable description based on the appropriate standard data dictionary corresponding to the EDI document.

9. A method as recited in claim 8, wherein said data dictionary is at least one XML document which correlates EDI codes with the metadata of the appropriate EDI standard.

10. A method as recited in claim 8 wherein said step (b) comprises selecting a tag structure describing the type of the piece of the EDI document.

11. A method as recited in claim 8 wherein said step (b) comprises selecting a tag structure from one of “Transaction_Set_XXX”, “Segment_XXX”, and “Element_XXX” where “XXX” is a space holder for insertoin of the EDI code into the tag structure.

12. A method as recited in claim 7, wherein the attribute name set in said step (d) is “desc.”

13. An XML document expressing the semantics of an EDI data dictionary, said XML document comprising:
an XML element including pair of corresponding tags, and an attribute that is equivalent to an EDI code in the EDI data dictionary; and
a child element including a pair of corresponding tags and a value that is equivalent to the metadata associated with the EDI code in the EDI data dictionary.

14. An XML document as recited in claim 1, further comprising, links to other XML documents expressing semantics of a portion of the EDI data dictionary.

15. An XML document as recited in claim 13, wherein the name of the tags of the XML element is one of “Transaction_Set”, “SegmentRef”, and “Element.”

16. An XML document as recited in claim 13, wherein the name of the tags of the child element is “name.”

17. An XML document having a plurality of elements designated by tags and expressing the underlying data and semantics of an EDI document, at least some of said elements of said XML document comprising:
the unique EDI code representing the type of information in the element; and
human readable metadata corresponding to the type of information in the element.

18. An XML document as recited in claim 17, wherein the unique EDI code is an attribute of the element and the metadata is the name of the tags designating the elements.
